(19) United States
(12) Patent Application Publication
(10) Pub. No.: US 2023/0127363 A1
(43) Pub. Date: Apr. 27, 2023

(54) Device and Method for Controlling a Vehicle Function of a Vehicle

(71) Applicant: Bayerische Motoren Werke Aktiengesellschaft, Muenchen (DE)

(72) Inventors: Philipp KERSCHBAUM, Muenchen (DE); Felix LAUBER, Muenchen (DE); Desiree MEYER, Stockdorf (DE); Frederik PLATTEN, Muenchen (DE)

(21) Appl. No.: 17/798,235

(22) PCT Filed: Jan. 21, 2021
(86) PCT No.: PCT/EP2021/051303

§ 371 Date: Aug. 8, 2022

(30) Foreign Application Priority Data
Feb. 13, 2020 (DE) 10 2020 103 785.6

(51) Int. Cl. B62D 1/04; B60W 50/00

(52) U.S. Cl. CPC B62D 1/046; B60W 50/0098; B60W 2540/223

(57) ABSTRACT

A device for controlling a vehicle function of a vehicle includes a steering device for manual lateral control of the vehicle, wherein the steering device has at least one touch sensor, which is designed to detect sensor data relating to a touching of the steering device by a driver of the vehicle. The device is designed to determine sensor data of the touch sensor and to carry out a hands-on detection for the steering device based on the sensor data of the touch sensor. As well as the hands-on detection, the device is also designed to operate a vehicle function of the vehicle according to the sensor data.

### BACKGROUND AND SUMMARY

The invention relates to a device and a method, by which a user interface can be provided for a driver of a vehicle, in particular a vehicle driving in an at least partially automated manner, via which at least one vehicle function of the vehicle can be controlled.

A vehicle can have one or more driving functions which enable at least partially automated driving of the vehicle. The one or more driving functions can each have different degrees of automation of the longitudinal and/or lateral control of the vehicle. For example, one driving function can be designed as a driver assistance system which enables partially automated longitudinal and/or lateral control of the vehicle according to SAE level 1. On the other hand, another driving function can enable, if appropriate, highly automated driving according to SAE level 2. One exemplary driving function is a parking assistant, which assists the driver of the vehicle during a parking maneuver of the vehicle.

Depending on the driving function, it can be required that the driver of the vehicle still touches or grasps the steering wheel of the vehicle with one or two hands. For a hands-on recognition, the steering wheel can comprise one or more touch sensors, which are designed to acquire a touch of the steering wheel. It can then be recognized on the basis of the sensor data of the one or more touch sensors whether the driver of the vehicle touches the steering wheel or not.

During the interaction with a user interface of the vehicle, it can be necessary, possibly also during operation of a driving function, for example, during operation of a parking assistant, that the driver of the vehicle takes at least one hand from the steering wheel to effectuate inputs at the user interface, for example, on a touch-sensitive display screen. This can be perceived to be uncomfortable by the driver of the vehicle and can possibly be contradictory to the hands-on requirement of an active driving function.

The present document relates to the technical problem of providing a particularly convenient user interface for a vehicle which can be used in particular also during operation of a driving function having a hands-on requirement for interactions between the driver and the vehicle.

The above-mentioned object is achieved by each individual one of the independent claims. Advantageous embodiments are described, among other things, in the dependent claims. It is to be noted that additional features of a claim dependent on an independent claim, without the features of the independent claim or only in combination with a subset of the features of the independent claim, can form a separate invention independent of the combination of all features of the independent claim, which can be made the subject matter of an independent claim, a divisional application, or a subsequent application. This applies in the same manner to technical teachings described in the description which can form an invention independent of the features of the independent claims.

The term “automated driving” can be understood in the scope of the document as driving having automated longitudinal or lateral control or automated driving having automated longitudinal and lateral control. Automated driving can involve, for example, driving over a longer time on the freeway or a highway or driving for a limited time in the context of parking or maneuvering. The term “automated driving” comprises automated driving with an arbitrary degree of automation. Exemplary degrees of automation are assisted, partially automated, highly automated, or fully automated driving. These degrees of automation were defined by the Bundesanstalt für Straßenwesen [German Federal Highway Research Institute] (BASt) (see BASt publication “Forschung kompakt [compact research]”, edition November 2012). In assisted driving, the driver continuously executes the longitudinal or lateral control, while the system takes over the respective other function in certain limits. In partially automated driving (TAF), the system takes over the longitudinal and lateral control for a certain period of time and/or in specific situations, wherein the driver has to continuously monitor the system as in assisted driving. In highly automated driving (HAF), the system takes over the longitudinal and lateral control for a certain period of time without the driver having to continuously monitor the system; however, the driver has to be capable of taking over the vehicle control in a certain time. In fully automated driving (VAF), the system can automatically manage the driving in all situations for a specific application; a driver is no longer necessary for this application. The above-mentioned four degrees of automation correspond to the SAE levels 1 to 4 of the norm SAE J3016 (SAE—Society of Automotive Engineering). For example, highly automated driving (HAF) corresponds to level 3 of the norm SAE J3016. Furthermore, the SAE level 5 is also provided as the highest degree of automation in SAE J3016, which is not included in the definition of the BASt. The SAE level 5 corresponds to driverless driving, in which the system can automatically manage all situations like a human driver during the entire journey; a driver is generally no longer required.

According to one aspect, a device is described for controlling a vehicle function of a vehicle. The vehicle function can comprise, for example, the output of an optical representation (for example with respect to the surroundings of the vehicle) on a display screen of the vehicle. Alternatively or additionally, the vehicle function can comprise the cleaning of a surroundings sensor (for example a camera) and/or a window of the vehicle. Alternatively or additionally, the vehicle function can comprise the setting of a vehicle parameter (for example the volume of an audio playback or the temperature of a heating or cooling function of the vehicle).

The vehicle comprises a steering device, in particular a steering wheel or handlebars, for manual lateral control of the vehicle. The steering device comprises at least one touch sensor which is designed to acquire sensor data with respect to a touch of the steering device by the driver of the vehicle.

The steering device can comprise at least one rod-shaped (in particular circular and/or bent or curved) steering device segment, in particular a steering wheel rim, which is designed, for the manual lateral control of the vehicle by the driver of the vehicle, to be touched at different touch positions along a linear touch region, in particular grasped with at least one hand. The touch sensor can be designed to acquire sensor data which indicate the touch position of a hand or finger of the driver on the steering device segment. Different touch positions along the rod-shaped steering device segment can possibly be indicated here with a specific position resolution (for example, of 1 position/cm or more).

The device can be configured (at a specific point in time) to ascertain sensor data of the touch sensor. Furthermore, the device can be configured to carry out a hands-on recognition for the steering device on the basis of the sensor data of the touch sensor. In particular, it can be recognized on the basis of the sensor data whether the driver of the vehicle touches the steering device, in particular the steering device segment, with at least one hand or not. The hands-on recognition on the basis of the sensor data of the touch sensor can be carried out during the operation of a driving function for at least partially automated driving of the vehicle. The driving function can then be executed or interrupted in dependence on the hands-on recognition. A safer operation of the driving function can thus be enabled.

The device is furthermore configured, in addition to the hands-on recognition, to operate a vehicle function of the vehicle in dependence on the sensor data. In particular, the device can be configured to use the sensor data of the touch sensor (in addition to the hands-on recognition) as part of a user interface of the vehicle, using which one or more vehicle functions of the vehicle can be controlled. The vehicle function, which is operated or controlled in dependence on the sensor data of the touch sensor, can be independent of the hands-on recognition and/or independent of a driving function for at least partially automated driving of the vehicle.

The device thus enables the one or more touch sensors on the steering device of a vehicle to be used both for the hands-on recognition and also as part of a user interface of the vehicle. In particular, the sensor data of the touch sensor can be used simultaneously for the hands-on recognition and for the provision of a user interface and/or for the control of a vehicle function. A particularly efficient and safe user interface for vehicle can thus be provided.

The device can be designed in particular to ascertain, on the basis of the sensor data of the touch sensor, the touch position at which the driver of the vehicle touches the rod-shaped steering device segment. The vehicle function of the vehicle can then be operated in dependence on the touch position. The interaction options of the driver of the vehicle with a vehicle function and thus the convenience and the scope of the user interface can thus be expanded.

The device can be configured to effectuate an optical representation dependent on the touch position on a display screen (for example, on the TFT display screen or on a head-up display) of the vehicle. In particular, the perspective of a representation of the surroundings of the vehicle reproduced on the display screen of the vehicle and/or an outside view of the vehicle can be set and/or adapted in dependence on the touch position.

The touch position can correspond to a specific angle on the steering wheel rim of the vehicle. A perspective can then be set which corresponds to the angle on the steering wheel indicated by the touch position. It can thus be made possible for the driver of the vehicle in a particularly convenient and reliable manner to set the perspective of a view of the vehicle and/or of the surroundings of the vehicle, which is represented on the display screen of the vehicle.

The device can be configured to detect a change of the touch position on the rod-shaped steering device segment (in particular on the steering wheel rim) on the basis of the sensor data of the touch sensor. In reaction thereto, the visual representation, in particular the perspective of the visual representation, on the display screen can then be adapted. The driver can thus change the perspective of the view displayed on the display screen in a convenient manner by changing the (touch) position of a finger or a hand on the steering device segment. For example, it can be made possible for the driver to have the perspective of the view circle around the vehicle by circling a finger or a hand around the steering wheel rim. The convenience of the user interface can thus be further increased.

The rod-shaped steering device segment can comprise at least one linear lighting element (for example, a chain made of LEDs), which extends along the linear touch region. The lighting element can be designed to selectively generate light signals in different partial regions of the linear lighting element. Furthermore, the device can be configured to cause the lighting element to selectively generate a light signal at the ascertained touch position. The lighting element can thus be used to indicate the (touch) position to the driver of the vehicle, at which the driver of the vehicle touches the steering device, in particular the steering device segment. In particular, it can be indicated to the driver by the light signal on the steering device which perspective a view represented on the display screen has. The convenience of the driver during the interaction with the vehicle can thus be further increased.

The device can be configured to ascertain a time curve of the touch position on the basis of the sensor data of the touch sensor. In other words, it can be ascertained how the driver of the vehicle has a finger or a hand slide over the steering device, in particular over the rod-shaped steering device segment or over the steering wheel rim.

On the basis of the time curve of the touch position, a gesture can then be detected which the driver of the vehicle effectuates by touching the rod-shaped steering device segment at different touch positions. The gesture can be selected or recognized here from a plurality of different, predefined gestures. The different gestures can be associated with different vehicle functions and/or with different control instructions to the vehicle.

The recognized gesture can comprise, for example, a movement in a first direction along the rod-shaped steering device segment (for example upward). Alternatively or additionally, the gesture can comprise a movement in an opposite second direction along the rod-shaped steering device segment (for example downward). In particular, the gesture can comprise a repeated, alternating movement in the first direction and in the second direction along the rod-shaped steering device segment. The number of repetitions and/or the extent of the movements can possibly be ascertained here.

The touch sensor of the steering device of the vehicle can thus be used to recognize one or more gestures of the driver. The device can be configured to operate the vehicle function in dependence on the detected gesture. The convenience of the user interface provided via the steering device can thus be further increased.

The vehicle function can comprise, for example, the cleaning of a surroundings sensor (in particular a camera) and/or a window of the vehicle, and the device can be configured to cause the cleaning of the surroundings sensor and/or the window in reaction to a recognized gesture. The intensity of the cleaning can possibly be set here via the extent and/or via the number of repetitions of the movements of a gesture. A particularly convenient control of the cleaning of a surroundings sensor and/or a vehicle window can thus be enabled.

The linear lighting element on the steering device segment can be designed to generate light signals having different lengths. The device can be configured to ascertain a required extent of the cleaning of the surroundings sensor and/or the vehicle window. In other words, it can be ascertained how severe the cleaning need of the surroundings sensor and/or the vehicle window is. The length of the light signal generated by the lighting element can then be adapted in dependence on the required extent of the cleaning of the surroundings sensor and/or the window.

In particular, the device can be configured to indicate on the basis of the length of the light signal generated by the lighting element how frequently the driver has to repeat the gesture until the cleaning of the surroundings sensor and/or the window is triggered. Alternatively or additionally, the device can be configured to effectuate a change of the length of the light signal generated by the lighting element as a consequence of an execution of the gesture in dependence on the required extent of the cleaning of the surroundings sensor and/or the window. Due to the adaptation of the length of the light signal effectuated at the steering device, the driver can be assisted in a precise manner in the control of the cleaning of a surroundings sensor and/or a vehicle window.

The device can be configured to set and/or adapt a parameter value of a vehicle parameter settable within a specific value range in dependence on the touch position. Exemplary vehicle parameters are: a parameter of an infotainment system and/or a climate control system of the vehicle; a volume of an audio signal played back by the vehicle; a component of highs and/or lows of an audio signal played back by the vehicle, and/or a setpoint temperature in a passenger compartment of the vehicle. For example, it can be made possible for the driver of the vehicle, by tapping on the steering device or by stroking along the steering device, in particular the steering device segment, to set the value of a vehicle parameter. A particularly convenient user interface (for example, for an infotainment system and/or for a climate control system of the vehicle) can thus be provided.

The device can be configured to set and/or adapt the length of the light signal generated by the lighting element in dependence on the parameter value. The value of a set vehicle parameter can thus be indicated to the driver of the vehicle in a precise and convenient manner.

According to a further aspect, a (road) motor vehicle (in particular a passenger vehicle or a truck or a bus or a motorcycle) is described which comprises the device described in this document.

According to a further aspect, a method for controlling a vehicle function of a vehicle is described, which comprises a steering device for manual lateral control of the vehicle. The steering device comprises at least one touch sensor, which is designed to acquire sensor data with respect to a touch of the steering device by a driver of the vehicle. The method comprises carrying out a hands-on recognition for the steering device on the basis of the sensor data of the touch sensor. Furthermore, the method comprises, in addition to the hands-on recognition, the operation of a vehicle function of the vehicle in dependence on the (possibly identical) sensor data of the touch sensor.

According to a further aspect, a software (SW) program is described. The SW program can be configured to be executed on a processor (for example, on a control unit of a vehicle), and to thus carry out the method described in this document.

According to a further aspect, a storage medium is described. The storage medium can comprise an SW program, which is configured to be executed on a processor, and to thus carry out the method described in this document.

It is to be noted that the methods, devices, and systems described in this document can be used both alone and also in combination with other methods, devices, and systems described in this document. Furthermore, any aspects of the methods, devices, and systems described in this document can be combined in manifold ways with one another. In particular, the features of the claims can be combined with one another in manifold ways.

The invention is described in more detail hereinafter on the basis of exemplary embodiments.

### BRIEF DESCRIPTION OF THE DRAWINGS

FIG. 1a shows exemplary components of a vehicle;

FIG. 1b shows an exemplary steering wheel of a vehicle;

FIGS. 2a and 2b show an exemplary control of a surroundings display of a vehicle by device of a steering wheel input;

FIGS. 3a to 3c show an exemplary control of a vehicle function by means of a steering wheel input;

FIGS. 4a to 4c show an exemplary setting of a parameter value by means of a steering wheel input; and

FIG. 5 is a flow chart of an exemplary method for providing a user interface for a vehicle.

### DETAILED DESCRIPTION OF THE DRAWINGS

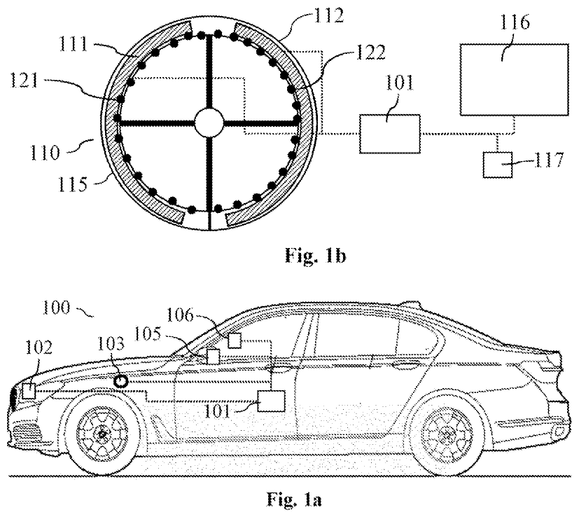

As described at the outset, the present document relates to providing a convenient user interface, which can possibly also be used in conjunction with a driving function, for a hands-on requirement. In this context, FIG. 1a shows exemplary components of a vehicle 100, in particular a motor vehicle. The vehicle 100 comprises one or more surroundings sensors 102, which are configured to acquire sensor data (in this document also referred to as surroundings data) with respect to the surroundings of the vehicle 100. Exemplary surroundings sensors 102 are a camera, a radar sensor, a lidar sensor, an ultrasonic sensor, etc.

The vehicle 100 furthermore comprises one or more longitudinal and/or lateral control actuators 103 (e.g., a drive motor, a braking device, a steering unit, etc.), which are configured to longitudinally and/or laterally control the vehicle 100 automatically or in an automated manner. A control unit 101 (or a device) of the vehicle 100 can be configured to operate the one or more longitudinal and/or lateral control actuators 103 of the vehicle as a function of the surroundings data in order to longitudinally and/or laterally control the vehicle 100 in an automated manner (in particular according to SAE level 1, according to SAE level 2, according to SAE level 3, or higher).

The vehicle 100 comprises one or more manual control devices 105, which enable the driver of the vehicle 100 to make manual control inputs with respect to the longitudinal and/or lateral control of the vehicle 100. Exemplary control devices 105 are: a steering wheel, a brake pedal, and/or an accelerator pedal. The control unit 101 can be configured (in particular when the vehicle 100 is operated in a manual driving mode) to detect a manual control input at a manual control device 105 of the vehicle 100. Furthermore, the control unit 101 can be configured to operate the one or more longitudinal and/or lateral control actuators 103 of the vehicle 100 as a function of the manual control input, in particular to enable the driver of the vehicle 100 to longitudinally and/or laterally control the vehicle 100 manually.

The vehicle 100 can comprise a user interface 106, which enables an interaction between the vehicle 100 and the driver of the vehicle 100. The user interface 106 can comprise one or more operating elements (e.g., a button, a rotary knob, etc.) and/or one or more output elements (e.g., a display screen, a lighting element, a loudspeaker, etc.). The control unit 101 can be configured to output an optical, haptic, and/or acoustic notice to the driver of the vehicle 100 via the user interface 106. Furthermore, it can be made possible for the driver of the vehicle 100 to activate or deactivate one or more driving functions (possibly having different degrees of automation) via the user interface 106.

FIG. 1b shows exemplary components of a vehicle 100 at the driver position of the vehicle 100. In particular, FIG. 1b shows a steering wheel 110 as an exemplary manual control or steering device 105, which enables the driver of the vehicle 100 to steer the vehicle 100 manually (in order to effectuate the lateral control of the vehicle 100). One or more touch sensors 121, 122 can be arranged on the steering wheel 110, which are configured to detect whether the driver of the vehicle 100 touches the steering wheel 110 with at least one hand. The control unit 101 can be configured to determine on the basis of the sensor data of the one or more touch sensors 121, 122 of the steering wheel 110 whether the driver of the vehicle 100 touches the steering wheel 110 with at least one hand, touches it with two hands, or does not touch it. Furthermore, FIG. 1b shows a display screen 116 and a loudspeaker 117 as exemplary components of the user interface 106.

The steering wheel 110 can furthermore have one or more lighting elements 111, 112, which can be activated or deactivated. A lighting element 111, 112 preferably has an elongated shape. In particular, a lighting element 111, 112 can be designed in such a way that the lighting element 111, 112 extends linearly along the circumference of the steering wheel rim 115. For example, a lighting element 111, 112 can extend over an angle range of 45° or more, in particular of 90° or 120° or more, along the circumference of the steering wheel rim 115.

A linear lighting element 111, 112 can have a plurality of partial segments (each having one or more LEDs), which can each be activated or deactivated individually. In other words, a linear lighting element 111, 112 can be designed in such a way that if needed only a part of the lighting element 111, 112 is activated, so that the length of a linear light signal emitted by the lighting element 111, 112 can be changed, in particular reduced or increased.

The one or more touch sensors 121, 122 on the steering wheel rim 115 of the steering wheel 110 can be designed to indicate the position, in particular the angle, at which the driver of the vehicle 100 touches the steering wheel rim 115. For this purpose, the one or more touch sensors 121, 122 can be divided into a plurality of partial segments, for example, to indicate the position of the touch of the steering wheel rim 115 with a specific position resolution or a specific angle resolution. For example, the circumference of the steering wheel rim 115 can be divided (possibly uniformly) into 10 or more, or into 20 or more partial segments, so that the position of the touch can be determined at an angle resolution of 360°/10 or less or at an angle resolution of 360°/20 or less, respectively, on the basis of the sensor data of the one or more touch sensors 121, 122.

The control unit 101 can be configured to adapt a display represented on the display screen 116 of the user interface 106 of the vehicle 100 in dependence on the sensor data of the one or more touch sensors 121, 122, in particular in dependence on the position at which the driver of the vehicle 100 touches the steering wheel rim 115. On the display, for example, the surroundings of the vehicle 100, such as a 360° bird's eye perspective of and/or around the vehicle 100 and/or of the surroundings of the vehicle 100 can be shown. The perspective of the view of the surroundings and/or the position of the camera using which the represented surroundings is acquired or represented can be adapted in dependence on the touch position of the steering wheel rim 115. It can thus be made possible for the driver of the vehicle 100, in particular in the case of a parking assistant, to show different views of the surroundings of the vehicle 100 on the display screen 116 in a convenient manner.

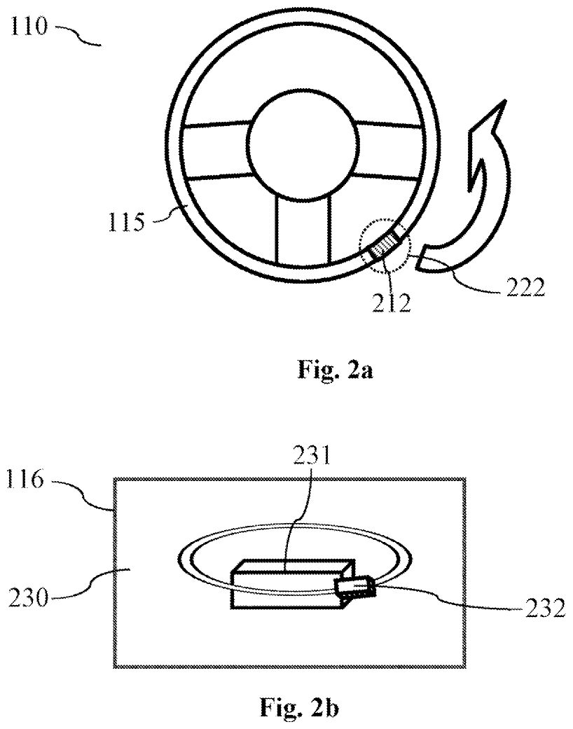

FIG. 2a shows an exemplary touch of the steering wheel rim 115 at a touch position 222. The touch position 222 can be ascertained on the basis of the sensor data of the one or more touch sensors 121, 122. FIG. 2b shows an exemplary visual representation 230 on a display screen 116 of the vehicle 100. The visual representation 230 comprises, for example, an external representation 231 of the vehicle 100. It can be made possible here for the driver of the vehicle 100 to change the virtual position of the camera 232, using which the external representation 231 of the vehicle 100 is acquired, by changing the touch position 222 (shown by the arrow in FIG. 2a). In particular, by circling along the circumference of the steering wheel rim 115, it is possible to cause the virtual position of the camera 232 to circle around the vehicle 100 (as shown by the ring in FIG. 2b).

The control unit 101 of the vehicle 100 can thus be designed to depict the (touch) position 222 of the hand or a finger on the steering wheel 110 directly or indirectly on a camera position. The point 222 of the touch and/or the point of the current camera position can be indicated as a light spot 212 on the lighting element 111, 112. Particularly convenient and reliable assistance of the driver of the vehicle 100 can be effectuated by such optical feedback with respect to the perspective of the optical representation 230 which is shown on the display screen 116.

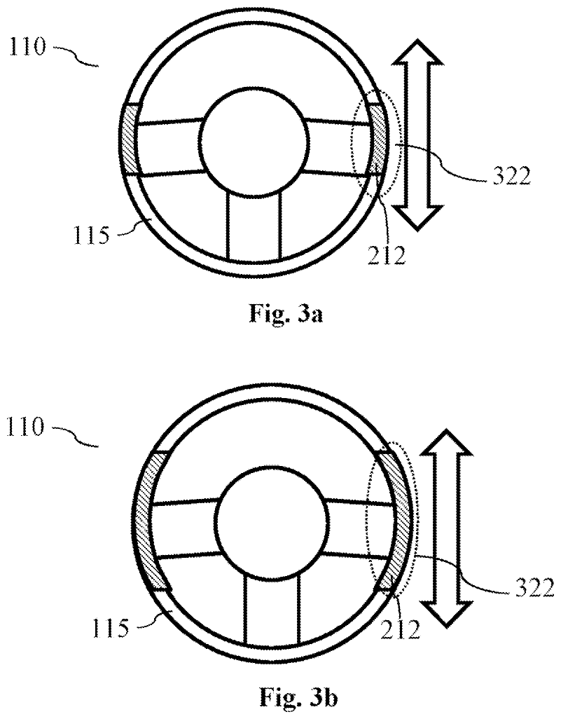

The control unit 101 can be configured to detect an upward and downward movement of one or both hands along the steering wheel rim 115 (as shown by way of example in FIGS. 3a to 3c) on the basis of the sensor data of the one or more movement sensors 121, 122. An extent of the upward and downward movement can also be ascertained. In particular, it can be ascertained which angle range of the steering wheel rim 115 is passed over during the upward and downward movement. Upward and downward movements having touch regions 322 of different sizes are shown by way of example in FIGS. 3a to 3c.

The touch region 322 passed over by the driver of the vehicle 100 can be indicated by a light signal 212 generated by the one or more lighting elements 111, 112. The length of the light signal 212 along the steering wheel rim 115 can correspond to the length of the touch region 322. In particular, the one or more lighting elements 111, 112 can be activated precisely in the partial regions which correspond to the touch region 322 of the upward and downward movement. Particularly convenient feedback with respect to an input, which is effectuated or can be effectuated via the steering wheel 110, can thus be given to the driver of the vehicle 100.

For example, the cleaning of one or more surroundings sensors 102 of the vehicle 100 can be effectuated by an upward and downward movement. The extent of the cleaning can be set, for example, via the length of the touch region 322 and/or via the number of repetitions of the upward and downward movement. Particularly convenient and precise cleaning of surroundings sensors 102 of the vehicle 100 can thus be enabled.

An interaction with the vehicle 100 can thus be effectuated by a gesture taking place on a circular path of the steering wheel rim 115. For example, cleaning of the camera lenses and/or other optical sensors in the vehicle 100 can be triggered by a (possibly repeated) upward and downward movement on both sides or on one side of the steering wheel 110.

Unnecessary cleaning of the one or more sensors 102 is typically undesired (for example, because of a relatively high water consumption and/or because of an impairment of a driving function for automated driving). The control unit 101 can be configured to determine whether cleaning of the one or more surroundings sensors 102 is required or not. An extent of the required cleaning can possibly be ascertained. The length of the touch region 322 and/or the number of repetitions of the gestures which are required to effectuate cleaning of the one or more surroundings sensors 102 can be changed in dependence on the ascertained extent of the required cleaning. In particular, the length of the touch region 322 to be effectuated and/or the required number of repetitions of the gestures can be reduced with increasing extent of the required cleaning, or vice versa. The triggering of the cleaning can thus be made more difficult by increasing the number of the required repetitions of the gesture if cleaning is not required or can be facilitated by reducing the number of the required repetitions of the gesture if cleaning is required.

The light display of the steering wheel 110 can be used as a feedback element. In particular, the one or more light signals 212 on the steering wheel rim 115 can be used to give feedback about the time and/or the number of the gesture repetitions still required until reaching the threshold value for triggering the sensor cleaning. For example, with each repetition of the gesture, the length of the one or more light signals 212 can be increased, wherein the sensor cleaning is initiated as soon as, for example, 100% of a lighting element 111, 112 is lit up. FIGS. 3a to 3c show by way of example a lengthening of the light signal 212 with increasing number of repetitions of the upward and downward movement. The driver of a vehicle 100 can thus be assisted in a reliable and convenient manner in the cleaning of the one or more surroundings sensors 102 of the vehicle 100.

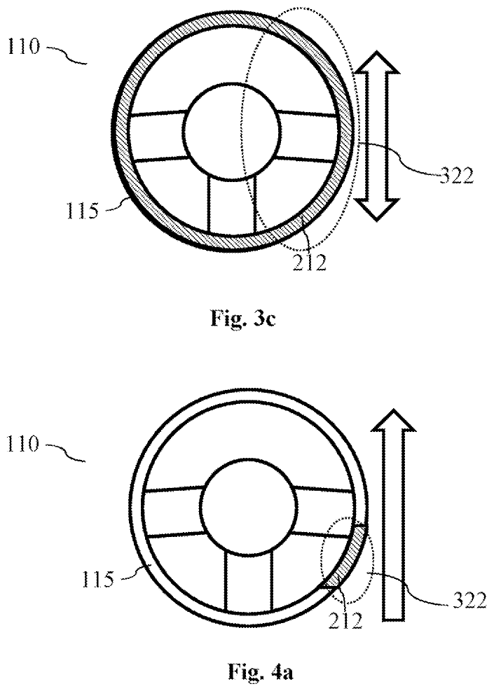

Alternatively or additionally, it can be made possible for the driver of the vehicle 100, for example, via a stroking movement upward or downward, along the steering wheel rim 115, to change a parameter value of a vehicle parameter settable in a specific value range (e.g., the playback volume of an audio signal or the setting of an equalizer), in particular to increase or reduce it. The set parameter value can be indicated via the length of the light signal 212 on the steering wheel rim 115. FIGS. 4a to 4c show exemplary stroke gestures (illustrated by the arrows) and light signals 212 of different lengths for parameter values of different levels.

The steering wheel lights 111, 112 can thus be used as a form of representation for bar diagrams. The length of a bar diagram can be changed via a stroke gesture. Thus, for example, the volume level (from 0% to 100%) can be shown (length of the light signal 212) and changed (level/fill level by upward/downward movements of the finger or the hand on the steering wheel 110). Alternatively or additionally, in a corresponding manner the bass or treble component of the music (equalizer function) can be depicted and parameterized. Furthermore, feedback with respect to the presently set (volume) level can possibly be provided via the length of the light signal 212.

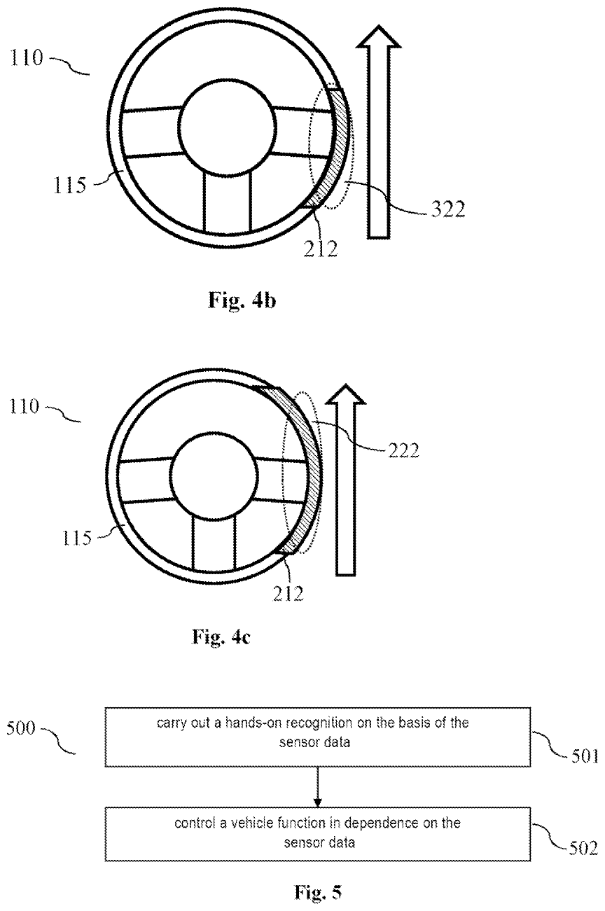

FIG. 5 shows a flow chart of an exemplary (computer-implemented) method 500 for controlling a vehicle function of a vehicle 100, which comprises a steering device 110, in particular a steering wheel or handlebars, for manual lateral control of the vehicle 100. The steering device 110 comprises at least one touch sensor 121, 122, which is designed to acquire sensor data with respect to a touch of the steering device 110 by a driver of the vehicle 100, in particular by at least one hand or at least one finger of the driver. The touch sensor 121, 122 can be designed, for example, as a capacitive and/or resistive sensor. The touch sensor 121, 122 can extend along the steering device 110.

The method 500 comprises carrying out 501 a hands-on recognition for the steering device 110 on the basis of the sensor data of the touch sensor 121, 122. In other words, the touch sensor 121, 122 can be used to recognize whether the driver of the vehicle 100 touches the steering device 110 with one or two hands. This can be necessary, for example, so that a driving function for at least partially automated driving is provided in the vehicle 100. For example, the driving function can be suppressed or terminated if it is recognized on the basis of the sensor data of the touch sensor 121, 122 that the driver holds no hands or does not hold both hands on the steering device 110. On the other hand, the driving function can possibly only be enabled when it is recognized on the basis of the sensor data of the touch sensor 121, 122 that the driver holds at least one hand on the steering device 110.

The method 500 furthermore comprises, additionally to and/or independently of the hands-on recognition, the operation 502 of a vehicle function of the vehicle 100 in dependence on the sensor data. The vehicle function is possibly independent here of the automated longitudinal and/or lateral control of the vehicle 100. For example, an optical representation 230 on a display screen 116 of the vehicle 100 can be effectuated in dependence on the sensor data of the touch sensor 121, 122 as a vehicle function.

The (already present) sensor system 121, 122 on a steering wheel 110, which is used to enable a hands-on recognition for a driving function, for example) can thus be used as part of a user interface 106 of a vehicle 100. In particular, a circumferential sensor system 121, 122 (for example 360° circumferentially) around the steering wheel rim 115 of a steering wheel 110 can be provided having a relatively fine position resolution. For example, the sensor system 121, 122 can be designed in such a way that the position of multiple fingers of a hand on the steering wheel 110 can be associated with a corresponding point 222 of the touch of the steering wheel rim 115. One or more (possibly already present) lighting elements 111, 112 on the steering wheel 110 can be used to assist the interaction. The touch sensor system 121, 122 can be used to control the content of a display screen 116 decoupled therefrom (for example, to set the perspective of a set scene) and/or to control a specific vehicle function (for example, the sensor cleaning). A particularly convenient and safe user interface 106 for a vehicle 100 can thus be provided.

The present invention is not restricted to the exemplary embodiments shown. In particular, it is to be noted that the description and the figures are only to illustrate the principle of the proposed methods, devices, and systems by way of example.

1.-16. (canceled)

17. A device for controlling a vehicle function of a vehicle, comprising:
a steering device for manual lateral control of the vehicle, the steering device comprising at least one touch sensor that acquires sensor data with respect to a touch of the steering device by a driver of the vehicle; and
a control unit operatively configured to:
ascertain the sensor data of the touch sensor;
carry out a hands-on recognition for the steering device based on the sensor data of the touch sensor; and
in addition to the hands-on recognition, operate a vehicle function of the vehicle in dependence on the sensor data.

18. The device according to claim 17, wherein
the steering device comprises at least one rod-shaped steering device segment, designed for the manual lateral control of the vehicle, to be touched by the driver of the vehicle at different touch positions along a linear touch region, and
the control unit is configured to:
ascertain, on the basis of the sensor data of the touch sensor, the touch position, at which the driver of the vehicle touches the rod-shaped steering device segment; and
operate the vehicle function of the vehicle in dependence on the touch position.

19. The device according to claim 18, wherein the control unit is configured to:
effectuate an optical representation on a display screen of the vehicle depending on the touch position; and/or
set and/or adapt a perspective of a representation of surroundings of the vehicle reproduced on a display screen of the vehicle, and/or an external view of the vehicle in dependence on the touch position.

20. The device according to claim 19, wherein the control unit is configured to:
detect a change of the touch position on the rod-shaped steering device segment on the basis of the sensor data of the touch sensor; and
in reaction thereto, adapt a perspective of the visual representation on the display screen.

21. The device according to claim 18, wherein
the rod-shaped steering device segment comprises at least one linear lighting element which extends along the linear touch region and generates light signals selectively in different partial regions of the linear lighting element; and
the control unit is configured to cause the lighting element to generate a light signal selectively at the ascertained touch position.

22. The device according to claim 18, wherein the control unit is configured to:
ascertain a time curve of the touch position on the basis of the sensor data of the touch sensor;
on the basis of the time curve of the touch position, detect a gesture which the driver of the vehicle effectuates by touching the rod-shaped steering device segment at different touch positions; and
operate the vehicle function in dependence on the detected gesture.

23. The device according to claim 22, wherein at least one of:
the gesture comprises a movement in a first direction along the rod-shaped steering device segment,
the gesture comprises a movement in an opposing second direction along the rod-shaped steering means segment, or
the gesture comprises a repeated alternating movement in the first direction and in the second direction along the rod-shaped steering means segment.

24. The device according to claim 22, wherein
the vehicle function comprises cleaning a surroundings sensor of the vehicle, and
the control unit is configured to effectuate the cleaning of the surroundings sensor in reaction to a detected gesture.

25. The device according to claim 24, wherein
the rod-shaped steering device segment comprises at least one linear lighting element, which extends along the linear touch region and generates light signals having different lengths, and
the control unit is configured to:
ascertain a required extent of the cleaning of the surroundings sensor; and
to adapt a length of the light signal generated by the lighting element in dependence on the required extent of the cleaning of the surroundings sensor.

26. The device according to claim 25, wherein the control unit is configured to:
indicate on the basis of the length of the light signal generated by the lighting element, how frequently the driver has to repeat the gesture until the cleaning of the surroundings sensor is triggered; and/or
effectuate a change of the length of the light signal generated by the lighting element as a result of an execution of the gesture in dependence on the required extent of the cleaning of the surroundings sensor.

27. The device according to claim 18, wherein
the control unit is configured to set and/or adapt a parameter value of a vehicle parameter settable within a specific value range in dependence on the touch position; and
the vehicle parameter comprises at least one of:
a parameter of an infotainment system and/or a climate control system of the vehicle;
a volume of an audio signal played back by the vehicle;
a component of highs and/or lows of an audio signal played back by the vehicle; or
a setpoint temperature in a passenger compartment of the vehicle.

28. The device according to claim 27, wherein
the rod-shaped steering device segment comprises at least one linear lighting element, which extends along the linear touch region and generates light signals having different lengths; and
the control unit is configured to set and/or adapt the length of the light signal generated by the lighting element in dependence on the parameter value.

29. The device according to claim 17, wherein
the steering device comprises a steering wheel having a steering wheel rim, and
the at least one touch sensor is designed to acquire sensor data with respect to a touch of the steering wheel rim by the driver of the vehicle.

30. The device according to claim 17, wherein
the control unit is configured to carry out the hands-on recognition on the basis of the sensor data of the touch sensor during operation of a driving function for at least partially automated driving of the vehicle, and/or
the vehicle function which is operated in dependence on the sensor data of the touch sensor is independent of the hands-on recognition and/or independent of the driving function for at least partially automated driving of the vehicle.

31. The device according to claim 17, wherein at least one of:
the vehicle function comprises output of an optical representation on a display screen of the vehicle,
the vehicle function comprises cleaning of a surroundings sensor of the vehicle, or
the vehicle function comprises setting of a vehicle parameter.

32. The device according to claim 18, wherein
the rod-shaped steering device comprises a steering wheel rim.

33. A method for controlling a vehicle function of a vehicle, which comprises a steering device for manual lateral control of the vehicle, wherein the steering device comprises at least one touch sensor designed to acquire sensor data with respect to a touch of the steering device by a driver of the vehicle,
wherein the method comprises:
carrying out a hands-on recognition for the steering device on the basis of the sensor data of the touch sensor; and
in addition to the hands-on recognition, operating a vehicle function of the vehicle in dependence on the sensor data.
